(19) United States
(12) Patent Application Publication
(10) Pub. No.: US 2015/0111589 A1
(43) Pub. Date: Apr. 23, 2015

(54) METHOD AND APPARATUS FOR OPTIMIZING COVERAGE AREA OF A SMALL CELL

(71) Applicant: QUALCOMM Incorporated, San Diego, CA (US)

(72) Inventors: Mehmet YAVUZ, San Diego, CA (US); Farhad MESHKATI, San Diego, CA (US); Rajat PRAKASH, San Diego, CA (US); Tao CHEN, San Diego, CA (US); Vinay CHANDE, San Diego, CA (US)

(73) Assignee: QUALCOMM Incorporated, San Diego, CA (US)

(21) Appl. No.: 14/244,152

(22) Filed: Apr. 3, 2014

Related U.S. Application Data
(60) Provisional application No. 61/892,987, filed on Oct. 18, 2013.

(51) Int. Cl. H04W 72/04; H04W 24/02; H04W 52/26

(52) U.S. Cl. CPC H04W 72/0486; H04W 52/267; H04W 24/02
USPC 455/452.1; 455/561

(57) ABSTRACT

The present disclosure presents a method and an apparatus for optimizing coverage area of a small cell. For example, the disclosure presents a method for estimating an available backhaul capacity of a small cell and determining a target OTA data rate for the small cell based at least on the estimated available backhaul capacity, and changing a coverage area of the small cell based at least on the determined target OTA data rate by. As such, optimizing coverage area of a small cell may be achieved.

### CLAIM OF PRIORITY UNDER 35 U.S.C. §119

The present application for patent claims priority to U.S. Provisional Patent Application No. 61/892,987, filed Oct. 18, 2013, entitled “Apparatus and Method for Optimizing Coverage Area of a Small Cell,” which is assigned to the assignee hereof, and hereby expressly incorporated by reference herein.

### BACKGROUND

The present disclosure relates generally to communication systems, and more particularly, to a method and an apparatus for optimizing coverage area of a small cell.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

To supplement conventional base stations, additional restricted power or restricted coverage base stations, referred to as small coverage base stations or cells, can be deployed to provide more robust wireless coverage to mobile devices. For example, wireless relay stations and low power base stations (e.g., which can be commonly referred to as Home NodeBs or Home eNBs, collectively referred to as H(e)NBs, femto nodes, pico nodes, etc.) can be deployed for incremental capacity growth, richer user experience, in-building or other specific geographic coverage, and/or the like. Such low power or small coverage (e.g., relative to macro network base stations or cells) base stations can be connected to the Internet via broadband connection (e.g., digital subscriber line (DSL) router, cable or other modem, etc.), which can provide the backhaul link to the mobile operator's network. Thus, for example, the small coverage base stations can be deployed in user homes to provide mobile network access to one or more devices via the broadband connection. Because deployment of such base stations is unplanned, low power base stations can interfere with one another where multiple stations are deployed within a close vicinity of one another.

In some small cell deployments, for example, neighborhood small cells, there may be limitations on the backhaul in terms of maximum supported throughout. However, in such deployments, the over the air (OTA) data rates supported by the small may exceed the backhaul capacity of the small cell resulting in inefficient use of the OTA resources.

Thus, there is a desire for a method and an apparatus for optimizing coverage area of a small cell.

### SUMMARY

Various aspects are now described with reference to the drawings. In the following description, for purposes of explanation, numerous specific details are set forth in order to provide a thorough understanding of one or more aspects. It may be evident, however, that such aspect(s) may be practiced without these specific details. The following presents a simplified summary of one or more aspects in order to provide a basis understanding of such aspects.

The present disclosure presents an example method and apparatus for optimizing coverage area of a small cell. For example, the present disclosure presents an example method for estimating an available backhaul capacity of a small cell, determining a target OTA data rate for the small cell based at least on the estimated available backhaul capacity, and changing a coverage area of the small cell based at least on the determined target OTA data rate.

In an additional aspect, an apparatus for optimizing coverage area of a small cell is disclosed. The apparatus may include means for estimating an available backhaul capacity of a small cell, means for determining a target OTA data rate for the small cell based at least on the estimated available backhaul capacity, and means for changing a coverage area of the small cell based at least on the determined target OTA data rate.

In a further aspect, a computer program product for optimizing coverage area of a small cell is described. The computer program product may include a computer-readable medium comprising code executable by a computer for estimating an available backhaul capacity of a small cell, determining a target OTA data rate for the small cell based at least on the estimated available backhaul capacity, and changing a coverage area of the small cell based at least on the determined target OTA data rate.

Moreover, the present disclosure presents an apparatus for optimizing coverage area of a small cell. The apparatus may include a backhaul capacity estimating component to estimate an available backhaul capacity of a small cell, a target OTA data rate determining component to determine a target OTA data rate for the small cell based at least on the estimated available backhaul capacity, and a parameter optimization component to change a coverage area of the small cell based at least on the determined target OTA data rate.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system in aspects of the present disclosure;

FIG. 2 is a block diagram illustrating an example coverage optimization manager in aspects of the present disclosure;

FIG. 3 is a flow diagram illustrating aspects of a method of distributed optimization of a self organizing network;

FIG. 4 is a block diagram illustrating aspects of a logical grouping of electrical components as contemplated by the present disclosure;

FIG. 5 is a illustrates an exemplary communication system to enable deployment of small cells within a network environment;

FIG. 6 is a block diagram illustrating aspects of a computer device according to the present disclosure;

FIG. 7 is a block diagram illustrating an example of a hardware implementation for an apparatus employing a processing system;

FIG. 8 is a block diagram conceptually illustrating an example of a telecommunications system;

FIG. 9 is a conceptual diagram illustrating an example of an access network; and

FIG. 10 is a block diagram conceptually illustrating an example of a NodeB in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure presents an example method and apparatus for optimizing coverage area of a small cell. For example, the data rates supported by a small cell may be limited by the available backhaul capacity of the small cell. Therefore, a target over the air (OTA) data rate is determined that is based at least on the available backhaul capacity and the coverage area of the small cell is changed (e.g., increased) to cover more area and/or UEs that otherwise would not be covered by the small cell.

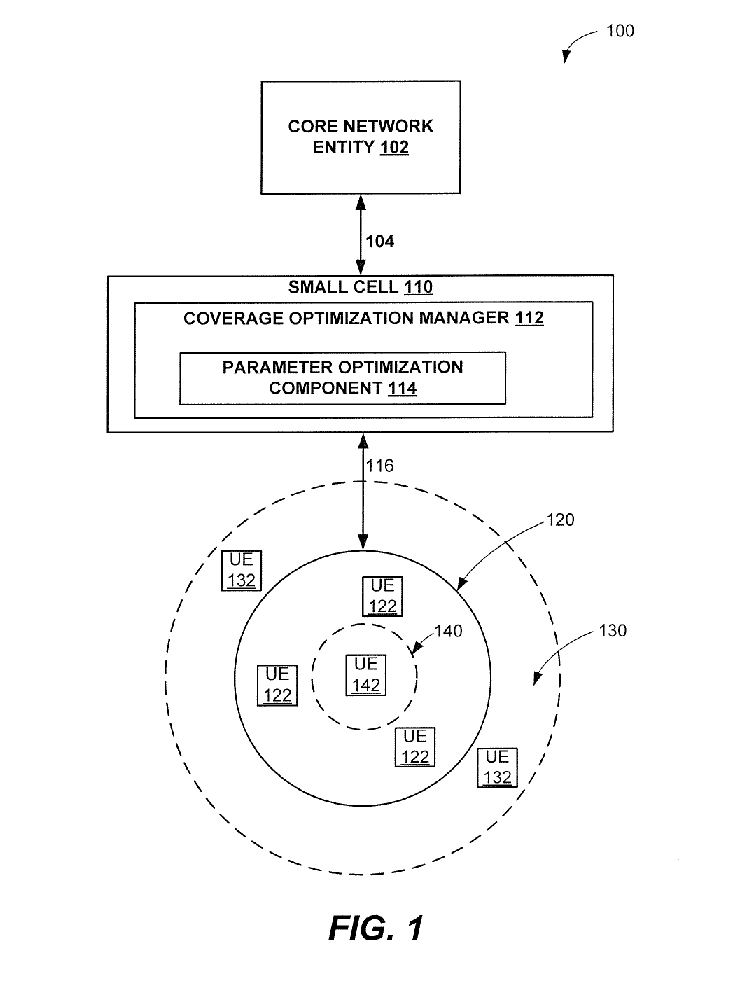

Referring to FIG. 1, a wireless communication system 100 is illustrated that facilitates optimizing coverage area of a small cell.

In an aspect, for example, system 100 may be a communications network that may include one or more base stations, for example, a small cell 110 in communication with a core network entity 102 via one or more communication links, for example, a link 104. System 100 may include one or more user terminals, for example, UE 122 in a coverage area 120 of small cell 110. The UE 122 may be in communication with the small cell over one or more over the air (OTA) links 116. FIG. 1 shows multiple UEs 122 in the coverage area 120 of small cell 110.

The term “small cell,” as used herein, refers to a relatively low transmit power and/or a relatively small coverage area cell as compared to a transmit power and/or a coverage area of a macro cell. Further, the term “small cell” may include, but is not limited to, cells such as a femto cell, a pico cell, access point base stations, Home NodeBs, femto access points, or femto cells. For instance, a macro cell may cover a relatively large geographic area, such as, but not limited to, several kilometers in radius. In contrast, a pico cell may cover a relatively small geographic area, such as, but not limited to, a building. Further, a femto cell also may cover a relatively small geographic area, such as, but not limited to, a home, or a floor of a building.

In an aspect, small cell 110 may be configured with a coverage optimization manager 112. The coverage optimization manager 112 facilitates optimizing coverage area of small cell 110. The coverage optimization manager 112 may optimize coverage area of the small cell by estimating an available backhaul capacity of a small cell, determining a target OTA data rate for the small cell based at least on the available backhaul capacity, and changing the coverage area of the small cell based at least on the determined target OTA data rate.

In an additional aspect, coverage optimization manager 112 may be configured to include a parameter optimization component 114. The parameter optimization component 112 changes, for example, increases or decreases, the coverage area of the small cell, by modifying one or more parameters of the small cell. For example, in an aspect, coverage optimization manager 112 may increase the coverage area of the small cell from coverage area 120 to coverage area 130 by modifying one or more parameters of the small cell. In an aspect, the parameters modified for increasing (or decreasing) the coverage area of the small cell may include transmit power of the small cell, number of resource elements at the small cell, transmit power of the pilot channels, operating bandwidth of the small cell, traffic-to-pilot ratio, etc. which are described below in detail.

In an additional or optional aspect, for example, coverage optimization manager 112 may decrease the coverage area of the small cell from coverage area 120 to coverage area 140 by modifying one or more parameters of the small cell. For example, in an aspect, the coverage area of small cell 110 may be decreased when it determined that the available backhaul capacity can support higher over the air (OTA) data rates at the UE.

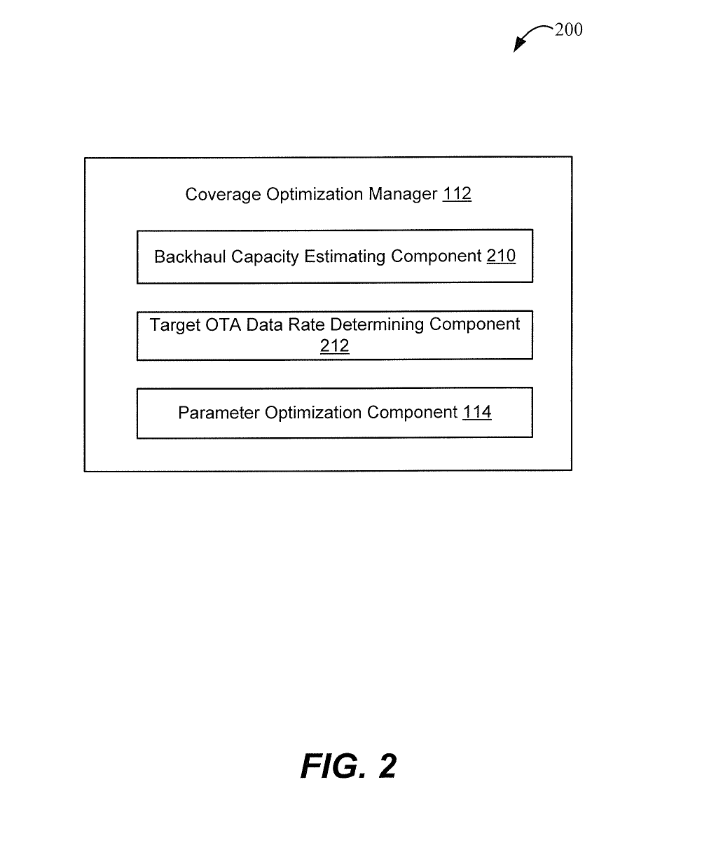

Referring to FIG. 2, an example coverage optimization manager in aspects of the present disclosure is illustrated.

In an aspect, coverage optimization manager 112, for example, of small cell 110, may be configured to include a backhaul capacity estimating component 210, a target OTA data rate determining component 212, and/or parameter optimization component 114.

In an aspect, backhaul capacity estimating component 210 may be configured to estimate available backhaul capacity of the small cell. For example, in an aspect, backhaul capacity estimating component 210 of small cell 110 may be configured to estimate the available capacity of link 104 which is used by small cell 110 to communicate with core network entity 102 for supporting one or more of UEs 122.

The backhaul capacity of small cell 110 that is available for UE 122 may depend on various factors. For example, in an aspect, link 104 may be shared with other wired/wireless devices on the small cell, e.g., Wi-Fi router, set top boxes, Wi-Fi TV, etc. thereby reducing the backhaul capacity available for UE 122. In an additional aspect, link 104 may encounter congestion that may affect the available backhaul capacity for supporting UE 122. In a further additional aspect, the available backhaul capacity for UE 122 may be dependent on the type of backhaul, e.g., fiber, digital subscriber line (DSL), cable modem, Ethernet, etc.

In an aspect, the available capacity of the backhaul may be estimated using several techniques. For example, in an aspect, the available capacity of the backhaul (e.g., link 104) may be estimated using light probing or heavy probing. In an additional aspect, the available capacity of the backhaul may be estimated by initiating a small download session over link 104 from a known server. In a further additional aspect, for example, the available capacity of backhaul 104 may be estimated by measuring round trip time (RTT) delays.

In an aspect, target OTA data rate determining component 212 may be configured to determine a target OTA data rate for the small cell based at least on the available backhaul capacity. For example, in an aspect, target OTA data rate determining component 212 may determine the target OTA data rate for small cell 110 based on the estimated available capacity of link 104.

For example, in an aspect, when estimated available backhaul capacity is 10 Mbps, target OTA data rate determining component 212 may determine that the target OTA rate for the small cell to be a value at or below 10 Mbps as the small cell may not be able to support data rates over 10 Mbps due to backhaul limitations. If the target OTA data rate is configured to a value above 10 Mbps, the OTA resources of the small cell are not being used efficiently. In an additional or optional aspect, a peak OTA data rate may be identified based on the configuration of the small cell. For example, in an aspect, peak OTA data rate supported by the small cell may be determined based on number of antennas and/or antenna configuration at the small cell.

In an aspect, parameter optimization component 114 may be configured to change coverage area of the small cell based on the determined target OTA data rate by modifying one or more parameters of the small cell. For example, in an aspect, the coverage area of small cell 110 may be changed based on the determined target OTA data rate by modifying one or more parameters of the small cell.

For example, the transmit power per resource element (RE) of the small cell may be increased to increase the coverage area of the small cell. The increased transmit power per RE of the small cell may provide extended coverage to enable the small cell to provide service to UEs that otherwise would have been outside the coverage of the small cell. For example, coverage area 130 in FIG. 1 illustrates an aspect where the coverage area of the small cell is increased, for example, by increasing the transmit power per RE of the small cell, which in turn may be able to provide service to one or more of UEs 132.

In an aspect, the number of resource elements at the small cell may be reduced when the transmit power per RE of the small cell is increased as the small cell may not use all the REs anyway due to limitations with the backhaul. In an additional aspect, this may allow for increasing the coverage area of the small cell by increasing the transmit power of the small cell. For example, the cell coverage area may be increased by increasing the transmit power on a reduced set of available REs, combined with increasing the power of common channels while keeping total radiated power over the entire bandwidth unchanged.

In an example aspect, the carrier operating bandwidth of a small cell may be changed. For example, a small may be operating on a 10 MHz or a 20 MHz carrier and the bandwidth of the operating carrier may be changed to a 5 MHz carrier. This is just an example, not a limitation, as the small cell may be operating on a carrier with a bandwidth of any size. In an aspect, the carrier bandwidth of the small cell may be reduced to increase the coverage area of the small cell by increasing the available power on the REs.

In an additional example aspect, the operating bandwidth of the carrier of the small cell may be changed based on operational measurements (OMs) collected at the small cell. For example, the small cell may decrease the operating bandwidth of the carrier based on the OMs collected by the small cell when the small cell determines that the coverage area of the small cell may be increased by putting more available power on the REs based on the information derived from the collected OMs.

In an additional or optional example aspect, the bandwidth of the operating carrier of a small cell may be configured at the time the small cell is initially turned ON or after the initial configuration. Additionally, the network operator may pre-configure the various carrier bandwidths (e.g., 5 MH, 10 MHz, 20 MHz, etc.) that may be configured at the small cell.

In an aspect, the transmit power of the common channels and/or pilots may be increased/decreased to support an increased/decreased coverage area of the small cell. For example, in an aspect when the transmit power of common channels is increased, the common channels may include, for example, common reference signal (CRS), primary synchronization signal (PSS), secondary synchronization signal (SSS), physical broadcast Channel (PBCH), and physical downlink control channel (PDCCH). The transmit powers of the common signals/pilots may be increased to support the extended coverage area of the small cell.

In an additional aspect, traffic to pilot (T2P) values, for example, Pa/Pb, may be increased/decreased to increase/decrease the coverage area of the small cell. In an aspect, the target number of hybrid automatic repeat request (HARQ) transmissions may be increased. For example, for a given transmit power, if the target number of HARQ transmissions is increased from 1 to 4 transmissions, a gain of 6 dB may be achieved to increase the coverage area of the small cell. Additionally, in an aspect, block error rate (BLER) target for HARQ processes may be increased to increase the coverage range of the small cell.

Additionally, various parameters may be modified at the small cell to change the coverage range of the small cell. For example, adjusting the aggregation level for PDCCH, limiting the number of resource blocks (RB) for PDCCH and PDSCH to keep the total transmit power below the maximum allowed power. For example, when pilot or control channels are boosted to improve the coverage area of the small cell, the PDSCH transmit power may be reduced or the number of RBs used for PDSCH may be reduced to compensate for the increase in the pilot/overhead/control channel power. In an aspect, when the transmit power of the common channels is increased, the peak OTA rates at the small cell may go down as power is being borrowed from the total power.

In an aspect, modifying parameters of the small cell may be semi-static or dynamic. For example, the parameters may be modified dynamically based on the estimated available backhaul capacity. In an optional aspect, the parameters may be modified in a semi-static manner, e.g., based on the time of day, number of users served by the small cell, small cell deployment density, UE capability, time of day and configuration aspects of the small cell such as MIMO configuration. The semi-static approach may be used to avoid frequently changing the coverage area of the small cell.

In an aspect, the parameters at the small cell may be modified to bias configuration of the small cell towards increasing the coverage range of the small cell or towards meeting the target OTA rate. For example, if more UEs are outside the coverage area of the small cell, the parameters may be modified to increase the coverage area of the small cell. In an additional example aspect, if more UEs are closer to the center of the small cell, the parameters may be modified to decrease the coverage area of the small, by reducing the transmit power of the small cell, so the small cell may support higher OTA rates.

In an optional aspect, the transmit power of the small cell may be reduced when it is determined that that more UEs are located closer to the center of the small cell, rather than at the edge of the cell or outside the coverage area of the cell. By reducing the coverage area of the cell, the small cell may support more UEs in that in present in the decreased coverage area and/or provide higher peak data rates.

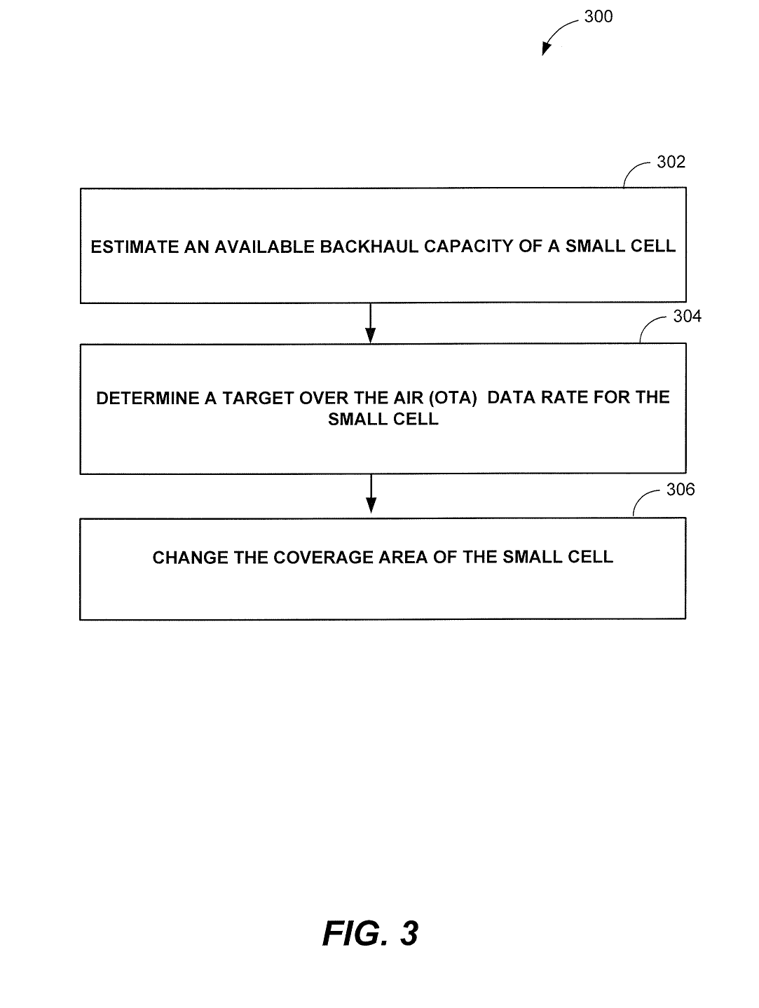

FIG. 3 illustrates an example methodology 300 for optimizing coverage area of a small cell. In an aspect, at block 302, methodology 300 may include estimating an available backhaul capacity of a small cell. For example, in an aspect, base station 110 and/or coverage optimization manager 112 and/or backhaul capacity estimating component 210 may be configured to estimate available backhaul capacity of a small cell. For example, the available backhaul capacity may be dependent on multiple factors as described above.

Furthermore, at block 304, methodology 300 may include determining a target OTA data rate for the small cell based at least on the estimated available backhaul capacity. For example, in an aspect, base station 110 and/or coverage optimization manager 112 and/or target OTA data rate identifying component 212 may be configured to determine a target OTA data rate for the small cell based at least on the estimated available backhaul capacity.

Additionally, at block 306, methodology 300 may include changing a coverage area of the small cell based at least on the determined target OTA data rate. For example, in an aspect, base station 110 and/or coverage optimization manager 112 and/or parameter optimizing component 114 may be configured to change the coverage area of the small cell based at least on the determined target OTA data rate. In an additional or optional aspect, for example, changing the coverage area of the small cell based at least on the determined OTA data rate may include modifying one or more parameters of the small cell as described in reference to FIG. 2 above.

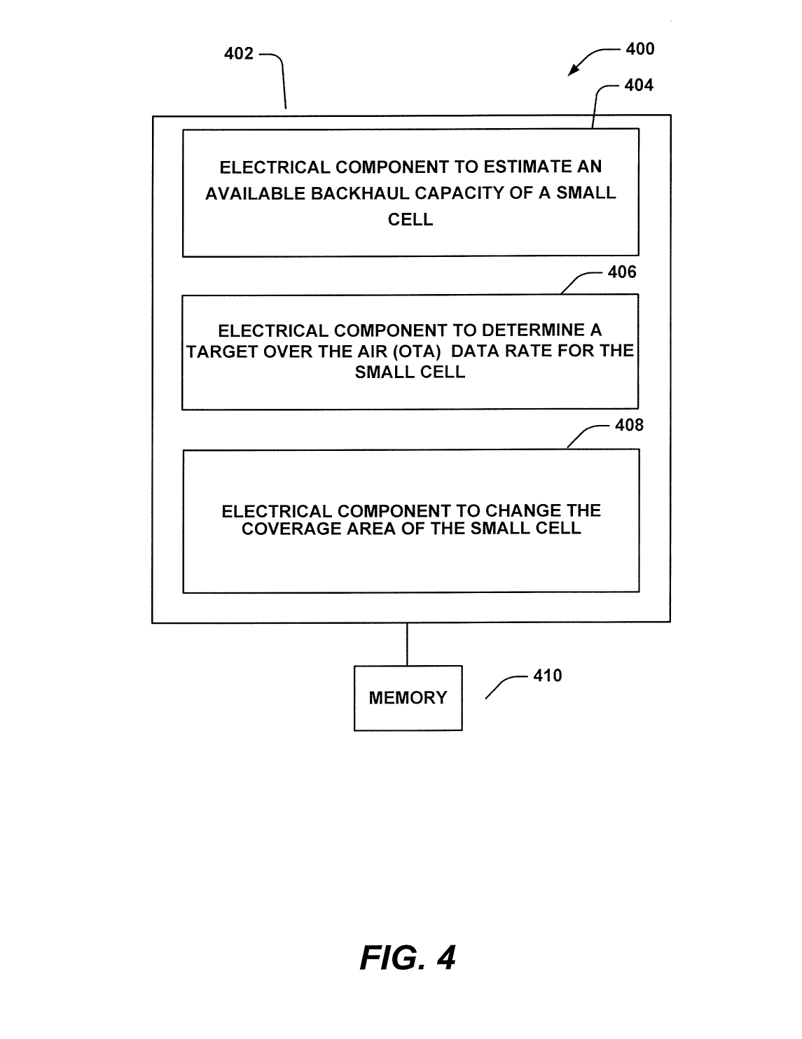

Referring to FIG. 4, an example system 400 is displayed for optimizing coverage area of a small cell. For example, system 400 can reside at least partially within small cell 110 (FIG. 1). It is to be appreciated that system 400 is represented as including functional blocks, which can be functional blocks that represent functions implemented by a processor, software, or combination thereof (for example, firmware). System 400 includes a logical grouping 402 of electrical components that can act in conjunction. For instance, logical grouping 402 can include an electrical component 404 for estimating an available backhaul capacity of a small cell. In an aspect, electrical component 404 may comprise backhaul capacity estimating component 210 (FIG. 2).

Additionally, logical grouping 402 can include an electrical component 406 for determining a target OTA data rate for the small cell based at least on the estimated available backhaul capacity. In an aspect, electrical component 406 may comprise target OTA data rate determining component 212 (FIG. 2). Furthermore, in an aspect, logical grouping 402 can include an electrical component 408 for changing a coverage area of the small cell based at least on the determined target OTA data rate. In an aspect, electrical component 408 may comprise parameter optimization component 114 (FIGS. 1-2).

Additionally, system 400 can include a memory 410 that retains instructions for executing functions associated with the electrical components 404, 406, and 408, stores data used or obtained by the electrical components 404, 406, and 408, etc. While shown as being external to memory 410, it is to be understood that one or more of the electrical components 404, 406, and 408 can exist within memory 410. In one example, electrical components 404, 406, and 408 can comprise at least one processor, or each electrical component 404, 406, and 408 can be a corresponding module of at least one processor. Moreover, in an additional or alternative example, electrical components 404, 406, and 408 can be a computer program product including a computer readable medium, where each electrical component 404, 406, and 408 can be corresponding code.

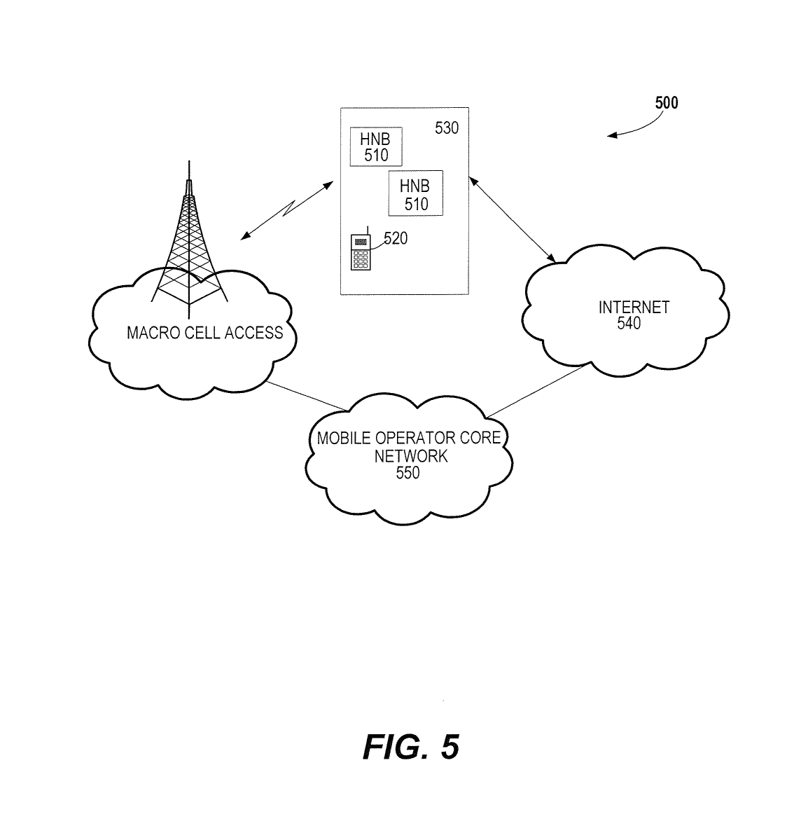

FIG. 5 illustrates an example communication system to enable deployment of base stations within a network environment. As shown in FIG. 5, system 500 includes multiple base stations or Home Node B units (HNBs) or small cells, such as, for example, HNBs 510, each being installed in a corresponding small scale network environment, such as, for example, in one or more user residences 530, and being configured to serve associated, as well as alien, user equipment (UE) 520. Each HNB 510 is further coupled to Internet 540 and a mobile operator core network 550 via a DSL router (not shown) or, alternatively, a cable modem (not shown).

Although aspects described herein use 3GPP terminology, it is to be understood that the aspects may be applied to 3GPP (Rel99, Rel5, Rel6, Rel7) technology, as well as 3GPP2 (1xRTT, 1xEV-DO Rel0, RevA, RevB) technology and other known and related technologies. In such aspects described herein, the owner of the HNB 510 subscribes to mobile service, such as, for example, 3G mobile service, offered through the mobile operator core network 550, and the UE 520 is capable to operate both in macro cellular environment and in residential small scale network environment. Thus, the HNB 510 is backward compatible with any existing UE 520.

Furthermore, in addition to the macro cell mobile network 550, the UE 520 can only be served by a predetermined number of HNBs 510, namely the HNBs 510 that reside within the user's residence 530, and cannot be in a soft handover state with the macro network 550. The UE 520 can communicate either with the macro network 550 or the HNBs 510, but not both simultaneously. As long as the UE 520 is authorized to communicate with the HNB 510, within the user's residence it is desired that the UE 520 communicate only with the associated HNBs 510.

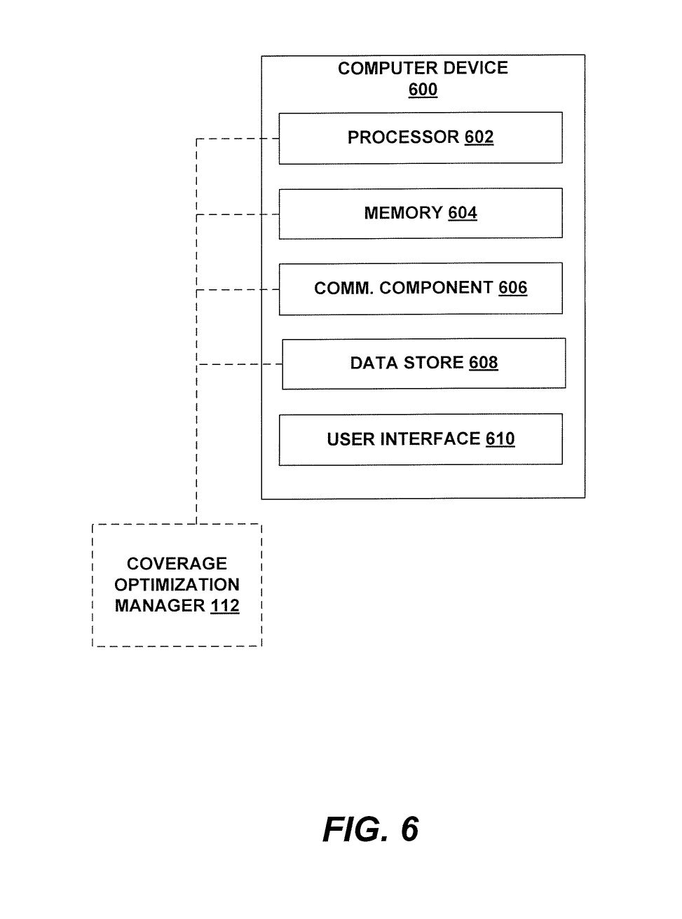

Referring to FIG. 6, in one aspect, one or more of small cells 110 (FIG. 1), including coverage optimization manager 112 (FIGS. 1-2) may be represented by a specially programmed or configured computer device 600. In one aspect of implementation, computer device 600 may include coverage optimization manager 112 (FIGS. 1-2), such as in specially programmed computer readable instructions or code, firmware, hardware, or some combination thereof. Computer device 600 includes a processor 602 for carrying out processing functions associated with one or more of components and functions described herein. Processor 602 can include a single or multiple set of processors or multi-core processors. Moreover, processor 602 can be implemented as an integrated processing system and/or a distributed processing system.

Computer device 600 further includes a memory 604, such as for storing data used herein and/or local versions of applications being executed by processor 602. Memory 604 can include any type of memory usable by a computer, such as random access memory (RAM), read only memory (ROM), tapes, magnetic discs, optical discs, volatile memory, non-volatile memory, and any combination thereof.

Further, computer device 600 includes a communications component 606 that provides for establishing and maintaining communications with one or more parties utilizing hardware, software, and services as described herein. Communications component 606 may carry communications between components on computer device 600, as well as between computer device 600 and external devices, such as devices located across a communications network and/or devices serially or locally connected to computer device 600. For example, communications component 606 may include one or more buses, and may further include transmit chain components and receive chain components associated with a transmitter and receiver, respectively, or a transceiver, operable for interfacing with external devices. In an additional aspect, communications component 606 may be configured to receive one or more pages from one or more subscriber networks. In a further aspect, such a page may correspond to the second subscription and may be received via the first technology type communication services.

Additionally, computer device 600 may further include a data store 608, which can be any suitable combination of hardware and/or software, that provides for mass storage of information, databases, and programs employed in connection with aspects described herein. For example, data store 608 may be a data repository for applications not currently being executed by processor 602 and/or any threshold values or finger position values.

Computer device 600 may additionally include a user interface component 610 operable to receive inputs from a user of computer device 600 and further operable to generate outputs for presentation to the user. User interface component 610 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 610 may include one or more output devices, including but not limited to a display, a speaker, a haptic feedback mechanism, a printer, any other mechanism capable of presenting an output to a user, or any combination thereof.

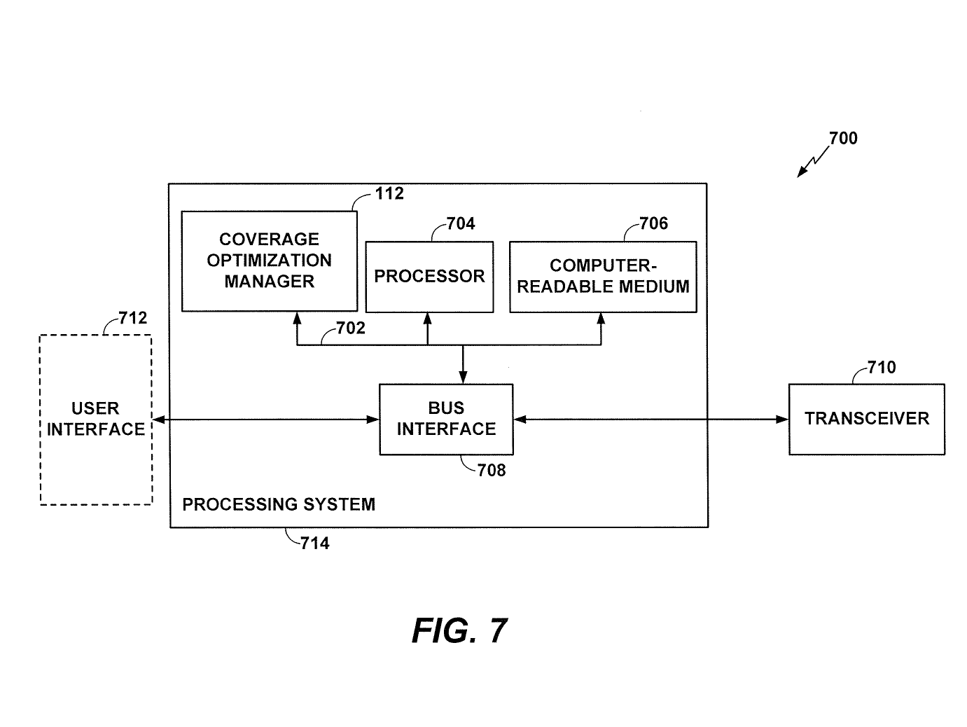

FIG. 7 is a block diagram illustrating an example of a hardware implementation for an apparatus 700, for example, including coverage optimization manager 112 of FIG. 1, employing a processing system 714 for carrying out aspects of the present disclosure, such as method for optimizing coverage area of a small cell. In this example, the processing system 714 may be implemented with bus architecture, represented generally by a bus 702. The bus 702 may include any number of interconnecting buses and bridges depending on the specific application of the processing system 714 and the overall design constraints. The bus 702 links together various circuits including one or more processors, represented generally by the processor 704, computer-readable media, represented generally by the computer-readable medium 707, and one or more components described herein, such as, but not limited to, coverage optimization manager 112 (FIGS. 1-2). The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 704 is responsible for managing the bus 702 and general processing, including the execution of software stored on the computer-readable medium 707. The software, when executed by the processor 704, causes the processing system 714 to perform the various functions described infra for any particular apparatus. The computer-readable medium 707 may also be used for storing data that is manipulated by the processor 704 when executing software.

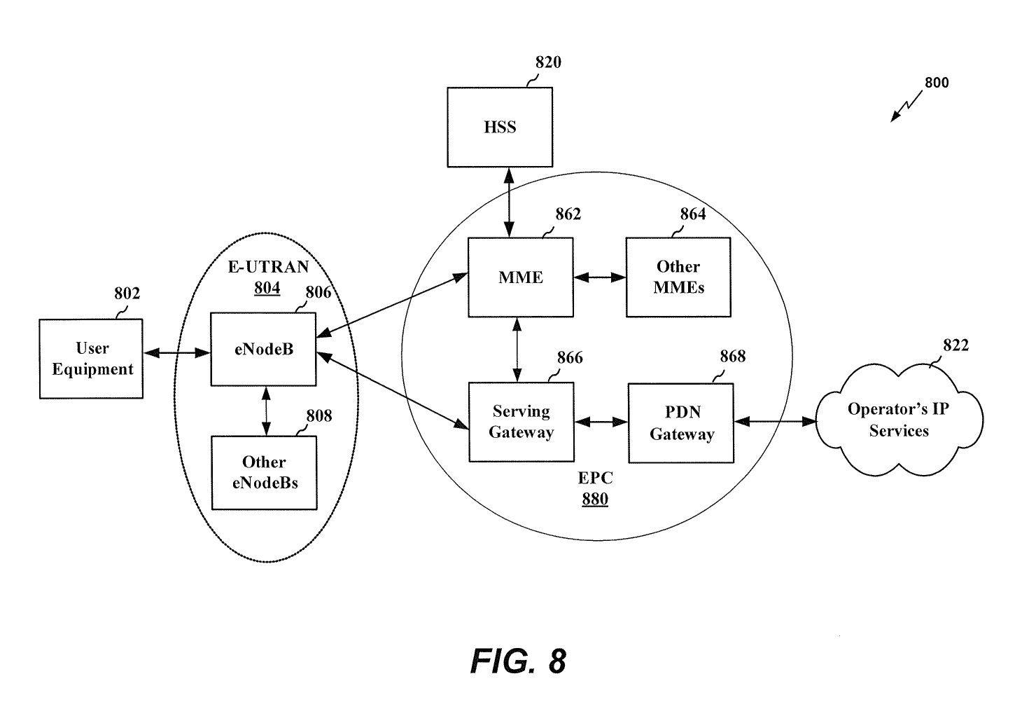

FIG. 8 is a diagram illustrating a long term evolution (LTE) network architecture 800 employing various apparatuses of wireless communication system 100 (FIG. 1) and may include one or more small cells configured to include coverage optimization manager 112 (FIGS. 1-2). The LTE network architecture 800 may be referred to as an Evolved Packet System (EPS) 800. EPS 800 may include one or more user equipment (UE) 802, an Evolved UMTS Terrestrial Radio Access Network (E-UTRAN) 804, an Evolved Packet Core (EPC) 880, a Home Subscriber Server (HSS) 820, and an Operator's IP Services 822. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 806 and other eNBs 808. The eNB 806 provides user and control plane protocol terminations toward the UE 802. The eNB 808 may be connected to the other eNBs 808 via an X2 interface (i.e., backhaul). The eNB 806 may also be referred to by those skilled in the art as a base station, a base transceiver station, a radio base station, a radio transceiver, a transceiver function, a basic service set (BSS), a small cell, an extended service set (ESS), or some other suitable terminology. The eNB 806 provides an access point to the EPC 880 for a UE 802. Examples of UEs 802 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 802 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 806 is connected by an S1 interface to the EPC 880. The EPC 880 includes a Mobility Management Entity (MME) 862, other MMEs 864, a Serving Gateway 866, and a Packet Data Network (PDN) Gateway 868. The MME 862 is the control node that processes the signaling between the UE 802 and the EPC 880. Generally, the MME 862 provides bearer and connection management. All user IP packets are transferred through the Serving Gateway 866, which itself is connected to the PDN Gateway 868. The PDN Gateway 868 provides UE IP address allocation as well as other functions. The PDN Gateway 868 is connected to the Operator's IP Services 822. The Operator's IP Services 822 include the Internet, the Intranet, an IP Multimedia Subsystem (IMS), and a PS Streaming Service (PSS).

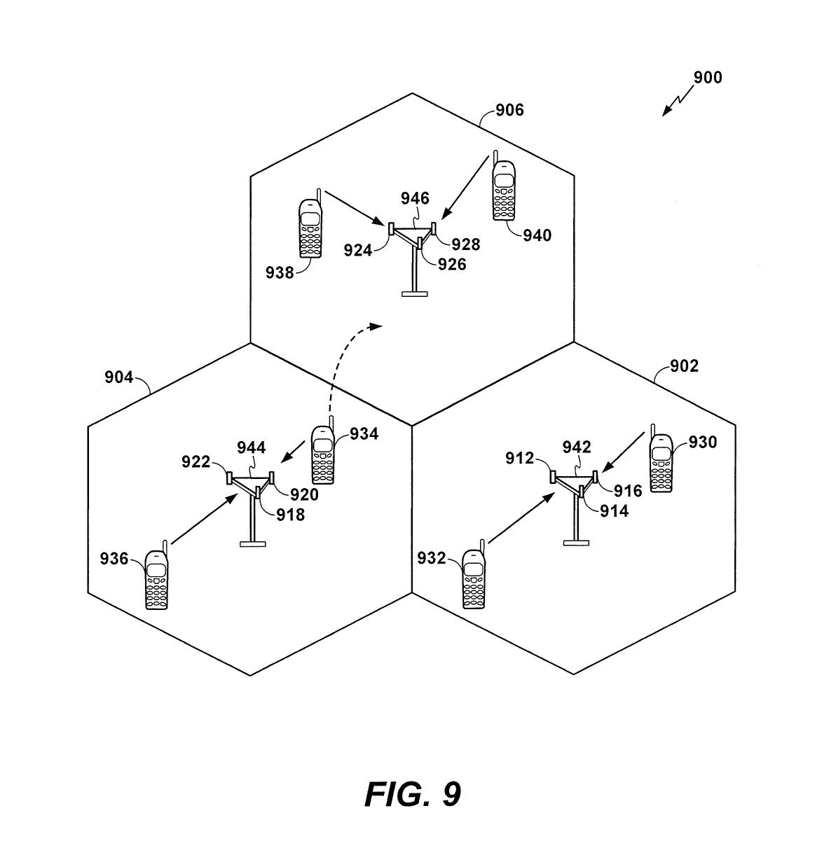

Referring to FIG. 9, an access network 900 in a UTRAN architecture is illustrated, and may include one or more base stations or small cells configured to include coverage optimization manager 112 (FIGS. 1-2). The multiple access wireless communication system includes multiple cellular regions (cells), including cells 902, 904, and 906, each of which may include one or more sectors and which may be one or more small cells 110 of FIG. 1. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 919, 920, and 922 each correspond to a different sector. In cell 906, antenna groups 924, 926, and 928 each correspond to a different sector. The cells 902, 904 and 906 may include several wireless communication devices, e.g., User Equipment or UEs, for example, including UEs 122, 132, and 142 of FIG. 1, which may be in communication with one or more sectors of each cell 902, 904 or 906. For example, UEs 930 and 932 may be in communication with NodeB 942, UEs 934 and 936 may be in communication with NodeB 944, and UEs 939 and 940 can be in communication with NodeB 946. Here, each NodeB 942, 944, 946 is configured to provide an access point for all the UEs 930, 932, 934, 936, 938, 940 in the respective cells 902, 904, and 906. Additionally, each NodeB 942, 944, 946 and UEs 930, 932, 934, 936, 938, 940 may be UEs 122, 132 of FIG. 1 and may perform the methods outlined herein.

As the UE 934 moves from the illustrated location in cell 904 into cell 906, a serving cell change (SCC) or handover may occur in which communication with the UE 934 transitions from the cell 904, which may be referred to as the source cell, to cell 906, which may be referred to as the target cell. Management of the handover procedure may take place at the UE 934, at the Node Bs corresponding to the respective cells, at a EPC 880 (FIG. 8), or at another suitable node in the wireless network. For example, during a call with the source cell 904, or at any other time, the UE 934 may monitor various parameters of the source cell 904 as well as various parameters of neighboring cells such as cells 906 and 902. Further, depending on the quality of these parameters, the UE 934 may maintain communication with one or more of the neighboring cells. During this time, the UE 934 may maintain an Active Set, that is, a list of cells that the UE 934 is simultaneously connected to (i.e., the UTRA cells that are currently assigning a downlink dedicated physical channel DPCH or fractional downlink dedicated physical channel F-DPCH to the UE 934 may constitute the Active Set). In any case, UE 934 may execute reselection manager 104 to perform the reselection operations described herein.

Further, the modulation and multiple access scheme employed by the access network 900 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 902.11 (Wi-Fi), IEEE 902.16 (WiMAX), IEEE 902.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

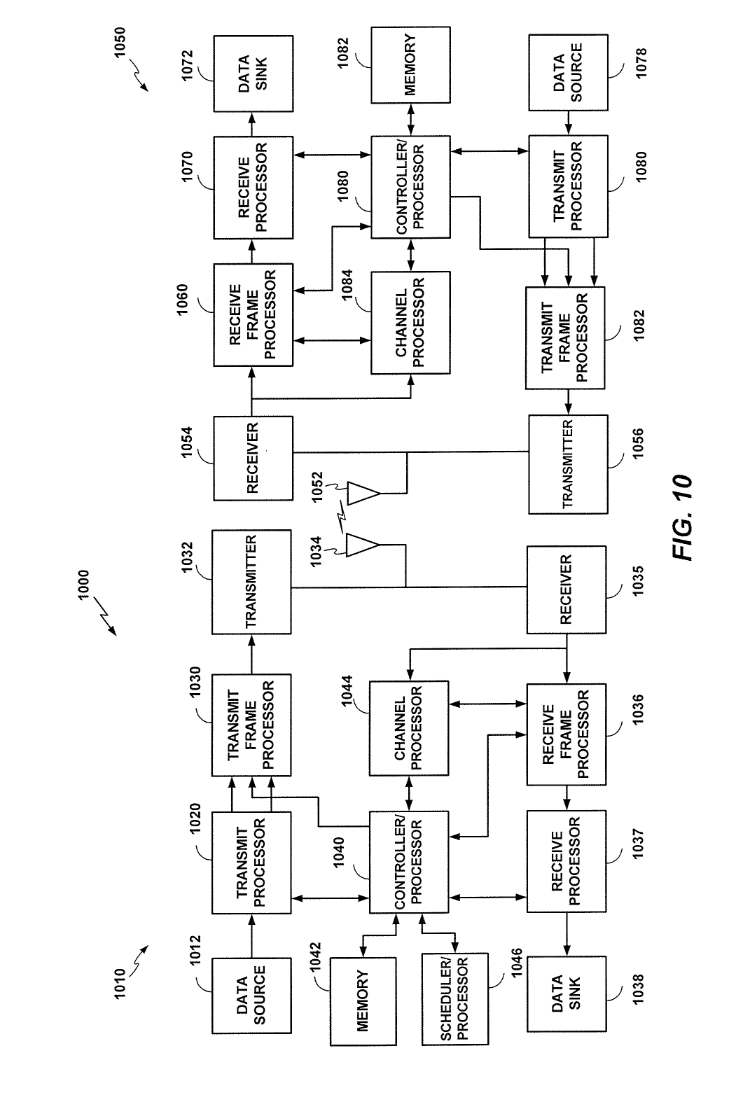

FIG. 10 is a block diagram of a NodeB 1010 in communication with a UE 1050, where the NodeB 1010 may one or more of small cells 110 and/or may include coverage optimization manager 112 (FIGS. 1-2). In the downlink communication, a transmit processor 1020 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the NodeB 1010. More specifically, the receive processor 1070 descrambles and de-spreads the symbols, and then determines the most likely signal constellation points transmitted by the NodeB 1010 based on the modulation scheme. These soft decisions may be based on channel estimates computed by the channel processor 1094. The soft decisions are then decoded and de-interleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receiver processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the NodeB 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the NodeB 1010 or from feedback contained in the midamble transmitted by the NodeB 1010, may be used to select the appropriate coding, modulation, spreading, and/or scrambling schemes. The symbols produced by the transmit processor 10100 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the NodeB 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the NodeB 1010 and the UE 1050, respectively. For example, the controller/processors 1040 and 1090 may provide various functions including timing, peripheral interfaces, voltage regulation, power management, and other control functions. The computer readable media of memories 1042 and 1092 may store data and software for the NodeB 1010 and the UE 1050, respectively. A scheduler/processor 1046 at the NodeB 1010 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer.

The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for optimizing a coverage area of a small cell, comprising:
estimating an available backhaul capacity of a small cell;
determining a target over the air (OTA) data rate for the small cell based at least on the estimated available backhaul capacity; and
changing the coverage area of the small cell based at least on the determined target OTA data rate.

2. The method of claim 1, wherein the coverage area of the small cell is changed by modifying one or more parameters of the small cell.

3. The method of claim 2, wherein the target OTA data rate is achieved by reducing available resource elements (RE) at the small cell.

4. The method of claim 2, wherein the changing of the coverage area of the small cell further comprises increasing transmit power per resource element (RE) at the small cell.

5. The method of claim 2, further comprising:
increasing transmit power of one or more common channels of the small cell.

6. The method of claim 5, wherein the one or more common channels are selected from a list comprising a common reference signal (CRS), a primary synchronization signal (PSS), a secondary synchronization signal (SSS), a physical broadcast channel (PBCH), and a physical downlink control channel (PDCCH).

7. The method of claim 2, wherein the coverage area of the small cell is changed by modifying an operating bandwidth or a traffic-to-pilot ratio of the small cell.

8. An apparatus for optimizing a coverage area of a small cell, comprising:
means for estimating an available backhaul capacity of a small cell;
means for determining a target over the air (OTA) data rate for the small cell based at least on the estimated available backhaul capacity; and
means for changing the coverage area of the small cell based at least on the determined target OTA data rate.

9. The apparatus of claim 8, wherein the coverage area of the small cell is changed by modifying one or more parameters of the small cell.

10. The apparatus of claim 9, wherein the target OTA data rate is achieved by reducing available resource elements (RE) at the small cell.

11. The apparatus of claim 9, wherein the changing of the coverage area of the small cell further comprises increasing transmit power per resource element (RE) at the small cell.

12. The apparatus of claim 9, further comprising:
means for increasing transmit power of one or more common channels of the small cell.

13. The apparatus of claim 12, wherein the one or more common channels are selected from a list comprising a common reference signal (CRS), a primary synchronization signal (PSS), a secondary synchronization signal (SSS), a physical broadcast channel (PBCH), and a physical downlink control channel (PDCCH).

14. The apparatus of claim 9, wherein the coverage area of the small cell is changed by modifying an operating bandwidth or a traffic-to-pilot ratio of the small cell.

15. A computer program product for optimizing a coverage area of a small cell, comprising a non-transitory computer-readable medium comprising code executable by a computer for:
estimating an available backhaul capacity of a small cell;
determining a target over the air (OTA) data rate for the small cell based at least on the estimated available backhaul capacity; and
changing the coverage area of the small cell based at least on the determined target OTA data rate.

16. The computer program product of claim 15, wherein the coverage area of the small cell is changed by modifying one or more parameters of the small cell.

17. The computer program product of claim 16, wherein the target OTA data rate is achieved by reducing available resource elements (RE) at the small cell.

18. The computer program product of claim 16, wherein the changing of the coverage area of the small cell further comprises increasing transmit power per resource element (RE) at the small cell.

19. The computer program product of claim 16, further comprising:
code for increasing transmit power of one or more common channels of the small cell.

20. The computer program product of claim 19, wherein the one or more common channels are selected from a list comprising a common reference signal (CRS), a primary synchronization signal (PSS), a secondary synchronization signal (SSS), a physical broadcast channel (PBCH), and a physical downlink control channel (PDCCH).

21. The computer program product of claim 16, wherein the coverage area of the small cell is changed by modifying an operating bandwidth or a traffic-to-pilot ratio of the small cell.

22. An apparatus for optimizing a coverage area of a small cell, comprising:
a backhaul capacity estimating component to estimate an available backhaul capacity of a small cell;
a target over the air (OTA) data rate determining component to determine a target OTA data rate for the small cell based at least on the estimated available backhaul capacity; and
a parameter optimization component to change the coverage area of the small cell based at least on the determined target OTA data rate.

23. The apparatus of claim 22, wherein the parameter optimization component is further configured to change the coverage area of the small cell by modifying one or more parameters of the small cell.

24. The apparatus of claim 23, wherein the target OTA data rate determining component target is further configured to achieve the OTA data rate by reducing available resource elements (RE) at the small cell.

25. The apparatus of claim 23, wherein the parameter optimization component is further configured to change the coverage area of the small cell by increasing transmit power per resource element (RE) at the small cell.

26. The apparatus of claim 23, wherein the parameter optimization component is further configured to increase transmit power of one or more common channels of the small cell.

27. The apparatus of claim 26, wherein the one or more common channels are selected from a list comprising a common reference signal (CRS), a primary synchronization signal (PSS), a secondary synchronization signal (SSS), a physical broadcast channel (PBCH), and a physical downlink control channel (PDCCH).

28. The apparatus of claim 22, wherein the coverage of the small cell is changed by modifying an operating bandwidth or a traffic-to-pilot ratio of the small cell.
